(19) United States
(12) Patent Application Publication
(10) Pub. No.: US 2012/0212181 A1
(43) Pub. Date: Aug. 23, 2012

(54) ELECTRIC POWER SUPPLY SYSTEM

(75) Inventor: Shizuo Tsuchiya, Gifu-city (JP)

(73) Assignee: DENSO CORPORATION, Kariya-city (JP)

(21) Appl. No.: 13/399,127

(22) Filed: Feb. 17, 2012

(30) Foreign Application Priority Data
Feb. 18, 2011 (JP) 2011-033465

(51) Int. Cl. H02J 7/00

(52) U.S. Cl. 320/109

(57) ABSTRACT

An electric power supply system has a sub breaker arranged in a sub line electrically connected with a power line to intercept an electrical link between a main breaker and the sub line if a predetermined value of current flows through the sub line. A current detector is arranged in the sub line to detect a value of current supplied to an energy storing portion. A controller causes a battery of a vehicle to store electricity with an electric current equal to or lower than a current value that is calculated by subtracting the value of current detected by the current detector from the predetermined value of current set for the sub breaker.

### CROSS REFERENCE TO RELATED APPLICATION

This application is based on Japanese Patent Application No. 2011-33465 filed on Feb. 18, 2011, the disclosure of which is incorporated herein by reference in its entirety.

### TECHNICAL FIELD

The present disclosure relates to an electric power supply system.

### BACKGROUND

JP-A-2001-174061 describes a water heater that stores heat as hot water by boiling water at midnight using electric power supplied from an electric power company. When the water heater is installed for a residence, a sub breaker is necessary for the water heater other than a main breaker so as to ensure the safety. The sub breaker limits electricity used for the water heater.

JP-A-2001-174061 also describes a charging of a battery mounted to a vehicle using the electric power at midnight, other than the electricity supply for the water heater.

When a person purchases an electric car or a plug-in hybrid car having a battery, it is necessary to install a charging pole for the car in a residence. Moreover, a sub breaker only for the charging of the battery is newly installed in order to improve the safety, apart from the main breaker, and limits electricity used for the charging of the battery.

If the residence is already equipped with the water heater, not only the sub breaker for the water heater but also the sub breaker for the charging are necessary. That is, money cost for increasing the sub breaker in the distribution board is additionally required for the person other than money cost for purchasing the car. Moreover, the person may have to change an electric power contracted with the electric power company. In this case, the basic power rate will be raised.

### SUMMARY

It is an object of the present invention to provide an electric power supply system that makes a battery-charging system easy and simple using existing equipment.

According to an example of the present disclosure, an electric power supply system that is supplied with electric power from an electric power supplier through a power line based on an electric power supply contract includes a main breaker, a sub breaker, an energy storing portion, a current detector and a controller. The main breaker is arranged in the power line to intercept an electrical link between the electric power supplier and the power line if a first predetermined value of current flows through the power line. The sub breaker is arranged in a sub line electrically connected with the power line to intercept an electrical link between the main breaker and the sub line if a second predetermined value of current flows through the sub line. The energy storing portion stores energy by being operated with the electric power supplied from the electric power supplier, and is electrically connected with the sub line. The current detector is arranged in the sub line to detect a value of current supplied to the energy storing portion. The controller controls an electricity storing operation of a battery and controlling an energy storing operation of the energy storing portion. The controller causes the battery to store electricity with an electric current equal to or lower than a current value that is calculated by subtracting the value of current detected by the current detector from the second predetermined value of current set for the sub breaker.

Accordingly, the electricity storing operation of the battery and the energy storing operation of the energy storing portion can be performed safely.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating an electric power supply system according to an embodiment;

FIG. 2 is a flow chart illustrating a processing performed by a controller of the electric power supply system;

FIG. 3 is a graph illustrating a relationship between a current and a duty ratio when a battery is charged with the electric power supply system;

FIG. 4 is a graph illustrating a controlling of current performed by the electric power supply system;

FIG. 5 is a flow chart illustrating a processing performed by the controller when a charging of the battery is prior to a heat storing operation of a water heater; and

FIG. 6 is a flow chart illustrating a processing performed by the controller when the heat storing operation of the water heater is prior to the charging of the battery.

### DETAILED DESCRIPTION

### Embodiment

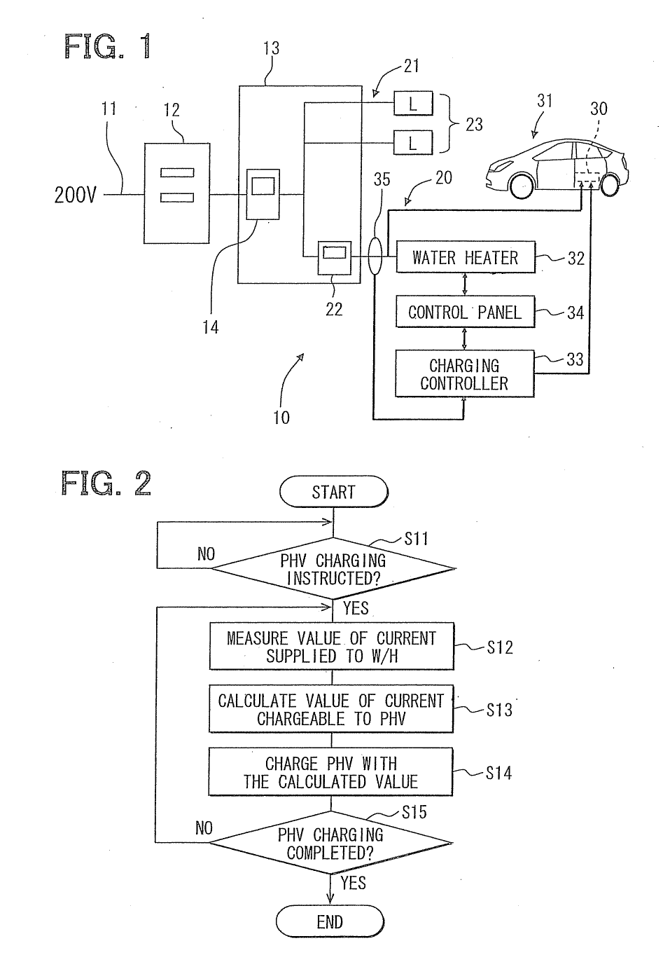

An embodiment of the present disclosure will be described with reference to FIGS. 1-6. FIG. 1 schematically shows a configuration of an electric power supply system 10 of the embodiment. The system 10 is supplied with electric power from an electric power supplier based on an electric power supply contract, and is able to store the electric power to a battery 30 of a vehicle 31.

Further, the electric power supply system 10 is able to supply the electric power to a water heater (W/H) 32 that stores the electric power as heat energy. The system 10 supplies the electric power for a residence through a parent power line 11 from the electric power supplier such as electric power utility company based on the electric power supply contract.

The contract is a single contract, in which cost of the electric power in a midnight (e.g., from 11 pm to 7 am) is set lower than that in the other time range. A power meter 12 is arranged in the parent power wiring 11, and records the electric power amount introduced into the residence through the wiring 11 on a time basis.

The residence has a distribution board 13 (breaker box), and the parent power wiring 11 is branched into plural circuits in the board 13. A main breaker 14 is arranged in the board 13 for the parent power wiring 11 before the branching. The main breaker 14 intercepts an electrical link between a domestic power network and the electric power supplier, when a predetermined or more current flows through the domestic power network. The main breaker 14 is a current limiter (ampere breaker) which opens an electric conduction path when a current exceeding the upper limit flows into the parent wiring 11. The upper limit is set in advance based on the electric power contracted with the electric power supplier.

In the distribution board 13, the parent wiring 11 is branched into a sub circuit 20 and a general circuit 21. The general circuit 21 is a part of the domestic power network, and supplies electric power for general loads 23 such as domestic lighting, air-conditioner, home electronics, and IH products.

The sub circuit 20 is a part of the domestic power network, and is used for charging the battery 30 and for supplying the electric power to the water heater 32.

Specifically, the sub circuit 20 charges the battery 30 of the plug-in hybrid vehicle (PHV) 31, for example, and supplies the electric power to the water heater 32.

The water heater 32 has a hot water storage tank (not shown) which stores hot water inside, and corresponds to a heat pump device that boils water into hot water and stores the hot water in the hot water storage tank. The heat pump device is equivalent to a heater, and the water heater 32 is equivalent to a heat storing portion that stores heat by operating the heater with the supplied electric power.

A sub breaker 22 is arranged in the sub circuit 20 as a safety breaker, power-source breaker or a ground fault breaker. If a predetermined or more current flows through the sub breaker 22, the sub breaker 22 intercepts the electrical link with the main breaker 14. That is, when unusual or superfluous electric current flows into the sub circuit, due to overload or short circuit, the sub breaker 22 opens the electric conduction path so as to intercept the supply of electric power to the sub circuit.

A charging controller 33 is connected to the sub circuit 20, and inputs a signal into the vehicle 31 for instructing the charging of the battery 30. The vehicle inputs the charged state of the battery 30 into the controller 33 as a PHV state information.

The controller 33 is arranged inside or outside of the residence having a parking space where the vehicle 31 is parked, for example. When a plug of a charge cable corresponding to a part of the sub circuit 20 is connected to a charge terminal of the vehicle 31, a signal wire extending from the controller 33 is connected to a signal input/output terminal of the vehicle 31, at the same time.

The controller 33 generates and outputs a control pilot (CPLT) signal based on a spec (standard) defined by a Society Automotive Engineers (SAE: registered trademark), for example. Thereby, the controller 30 transmits signals to or from the battery 30.

A control panel 34 is placed inside or outside of the residence, and is connected to the controller 33. The control panel 34 has a display (not shown) and a charging start switch (not shown). The display displays information about the charged state of the battery 30. The start switch is an operate portion through which the charging of the battery 30 is instructed to the vehicle 31. The operate portion may be located in the vehicle 31. The control panel 34 is electrically connected to a control portion (not shown) of the water heater 32. The water heater 32 is controlled through the control panel 34. For example, the water heater 32 is operated to start using a timer through the control panel 34, or an amount of the hot water stored in the water heater 32 can be set by the control panel 34.

A current detector 35 is arranged in the sub circuit 20, and detects a value of current flowing through the sub circuit. The detector 35 is connected to the controller 33, and the current value detected by the detector 35 is input to the controller 33. The detector 35 detects the value of current supplied to the water heater 32.

Operation of the system 10 that is controlled by the controller 33 will be described with reference to FIG. 2. The flow chart of FIG. 2 is executed when the controller 33 is energized.

At S11, it is determined whether the charging of the battery 30 is instructed for the vehicle 31. If there is no instruction for the charging, S11 is repeated. If there is an instruction for the charging, the processing is advanced to S12. Specifically, when the plug of the charge cable is connected to the charge terminal of the vehicle 31 and when the instruction for the charging is detected to be input to the control panel 34, it is determined that there is the instruction for the charging.

At S12, the controller 33 obtains the signal detected by the current detector 35, and the processing is advanced to S13.

At S13, a value of current able to be supplied to the battery 30 is calculated using the current value supplied to the water heater 32. Specifically, an upper limit of the current able to the supplied to the battery 30 is calculated by subtracting the current value supplied to the water heater 32 from an allowable upper limit current value of the sub breaker 22. Thus, the value of current supplied to the battery 30 is suitably set by the calculation within a range having the upper limit. For example, the calculated value of current supplied to the battery 30 is compared with the upper limit, and the smaller one between the calculated value and the upper limit is selected.

At S14, the battery 30 is charged with the current value determined at S13. At S15, it is determined whether the charging of the battery 30 is completed. If the charging is not completed, the processing is returned to S12, and the charging is continued. If it is determined that the charging is completed at S15, the flow chart of FIG. 2 is ended.

In FIG. 2, the controller 33 causes the battery 30 to store electricity with an electric current equal to or lower than a current value that is calculated by subtracting the value of current supplied to the water heater 32 from the allowable upper limit current value of the sub breaker 22. Therefore, the total of the current values supplied to the battery 30 and the water heater 32 does not exceed the allowable upper limit current value of the sub breaker 22 even if the charging of the battery 30 and the operation of the water heater 32 are simultaneously performed in midnight during which the cost of electric power is less expensive than that in the other time range.

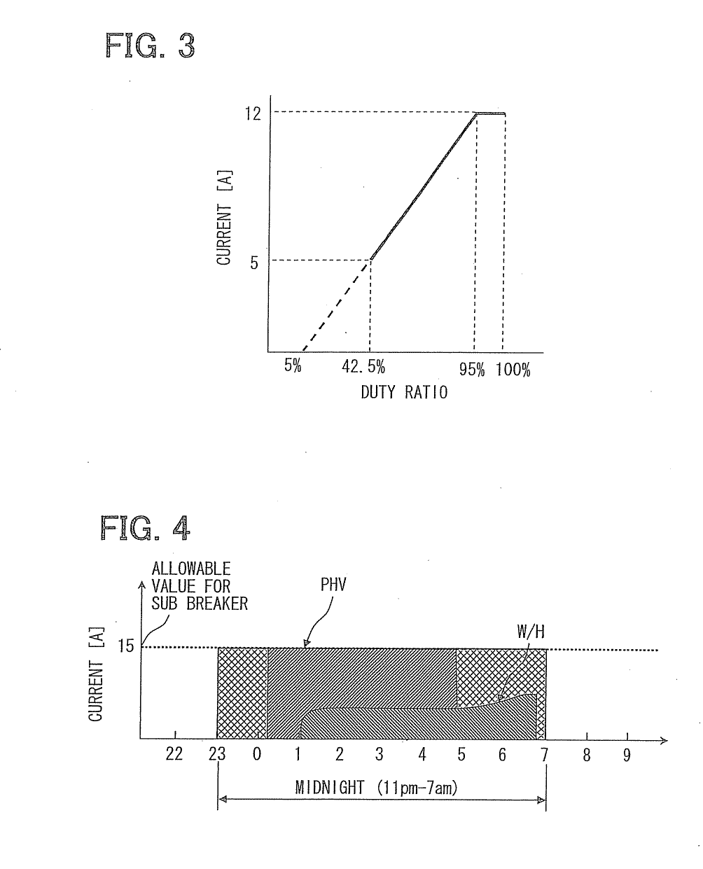

Controlling of the charging current performed by the controller 33 will be described with reference to FIG. 3. Graph of FIG. 3 illustrates an example relationship between current and duty ratio when the batterry 30 is charged. The controller 33 controls the value of charging current by controlling the duty ratio of the CPLT signal. When the water heater 32 is not active, all the allowable value of current for the sub breaker 22 can be used, so that the controller 33 generates a CPLT signal having duty ratio of 100%. Thereby, as shown in FIG. 3, the battery 30 is charged with the current value of 12A in this case.

While the water heater 32 is operating to store heat, the battery 30 is charged with the current value calculated at S13 of FIG. 2. For example, when the sub breaker 22 has the allowable upper limit of current as 20A, and when the heat storing operation of the water heater 32 consumes the current of 10A, the battery 30 is charged with the current of 5A considering an operational error of the sub breaker 22. In this case, a CPLT signal having duty ratio of 42.5% is generated by the controller 33. Thus, the charging current is suitably controlled by controlling the duty ratio.

FIG. 4 is a graph illustrating an example current controlling performed by the electric power supply system 10. As shown in FIG. 4, when the sub breaker 22 has an actual upper limit current of 20A, the allowable limit value of the sub breaker 22 is set as 15A considering an operational error of the sub breaker 22.

The heat storing operation of the water heater 32 and the charging operation of the battery 30 may be simultaneously performed at midnight represented by a cross-hatching of FIG. 4. A diagonally-right-down hatching area represents the current used for the water heater 32, and a diagonally-right-up hatching area represents the current used for the battery 30. That is, an area except the diagonally-right-down hatching area can be used for the charging of the battery 30. In the example of FIG. 4, the charging of the battery 30 is started around 0 am and is ended around 5 am, as shown by the diagonally-right-up hatching area.

Therefore, the total of the current values for the water heater 32 and the battery 30 does not exceed the allowable limit current of the sub breaker 22 even if the charging of the battery 30 and the operation of the water heater 32 are simultaneously performed in midnight during which the cost of electric power is less expensive than that in the other time range. In such a manner, the controller 33 controls the charging current so as to charge the battery 30.

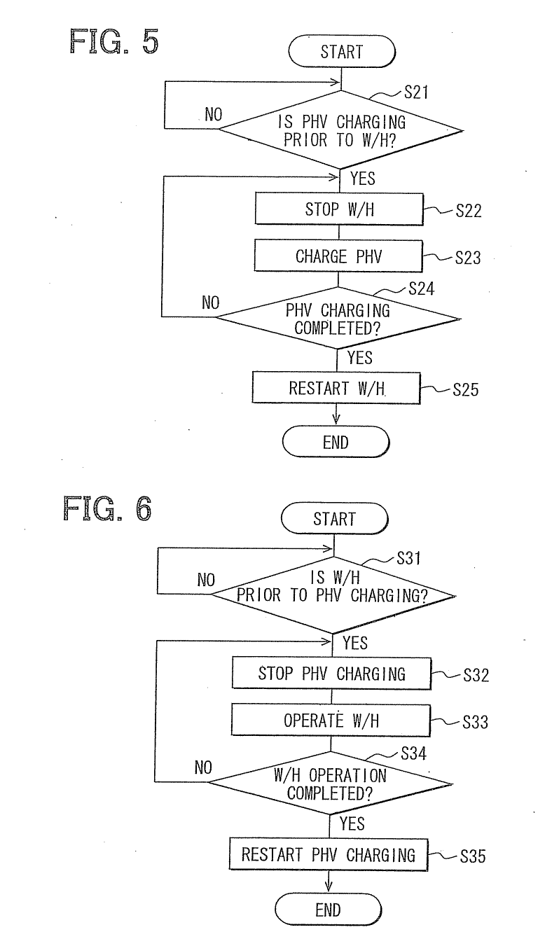

A processing of the controller 33 in a case where the charging is prior to the heat storing operation will be described with reference to FIG. 5.

At S21, it is determined whether there is an instruction that the charging is prior to the heat storing operation. If there is no such instruction, S21 is repeated. If there is an instruction that the charging is prior to the heat storing operation, the processing is advanced to S22. Specifically, when the plug of the charge cable is connected to the charge terminal of the vehicle 31 and when the instruction that the charging is prior to the heat storing operation is detected through the switch of the control panel 34, it is determined that there is the instruction. Further, when a switch for starting the charging is operated, it is determined that there is the instruction that the charging is prior to the heat storing operation.

At S22, the controller 33 outputs a signal prohibiting the heat storing operation into the water heater 32, thereby prohibiting the operation of the heat pump device, and the processing is advanced to S23. The signal stops the heat storing operation when the water heater 32 is conducting the heat storing operation. The stop state of the heat storing operation is maintained when the water heater 32 is not conducting the heat storing operation.

At S23, the controller 33 instructs the vehicle 31 to charge the battery 30, and the processing is advanced to S24. Because the heat storing operation of the water heater 32 is stopped when the charging of the battery 30 is started, all the allowable current of the sub breaker 22 can be used for the charging, so that a CPLT signal having the duty ratio of 100% is generated. Thus, the charging CaO be performed with the maximum current.

At S24, it is determined whether the charging of the battery 30 is completed. If the charging is not completed, the processing is returned to S22, and the charging is continued. If it is determined that the charging is completed at S24, the processing is advanced to S25.

At S25, a signal instructing to restart the heat storing operation is output so as to cancel the prohibition of the operation of the heat pump device.

When there is the instruction that the charging of the battery 30 is prior to the power supply for the heat pump device, the controller 33 prohibits the operation of the heat pump device when the charging of the battery 30 is started. When the charging of the battery 30 is completed, the prohibited state is canceled so as to enable the heat storing operation of the water heater 32. Thus, the battery 30 can be charged with upper limit current corresponding to the allowable upper limit current of the sub breaker 22. In this case, the charging of the battery 30 and the operation of the water heater 32 are not simultaneously performed, so that the total of the current values does not exceed the allowable upper limit of the sub breaker 22.

A processing of the controller 33 in a case where the heat storing operation is prior to the charging will be described with reference to FIG. 6.

At S31, it is determined whether there is an instruction that the heat storing operation is prior to the charging. If there is no such instruction. S31 is repeated. If there is an instruction that the heat storing operation is prior to the charging, the processing is advanced to S32. Specifically, when the instruction that the heat storing operation is prior to the charging is detected through the switch of the control panel 34, it is determined that there is the instruction.

At S32, the controller 33 inputs a signal prohibiting the charging of the battery 30, and the processing is advanced to S33. Thereby, the charging of the battery 30 is prohibited when the battery 30 is charged. When the battery 30 is not being charged, the stop state of the charging is maintained.

At S33, the controller 33 instructs the water heater 32 to start the heat storing operation, and the processing is advanced to S34.

At S34, it is determined whether the heat storing operation is completed. If the heat storing operation is not completed, the processing is returned to S32, and the heat storing operation is continued. If it is determined that the heat storing operation is completed at S34, the processing is advanced to S35.

At S35, the prohibition of the charging of the battery 30 is canceled to allow the charging of the battery 30 to restart.

When there is the instruction that the power supply for the heat pump device is prior to the charging of the battery 30, the controller 33 prohibits the charging operation when the power supply for the water heater 32 is started. When the heat storing operation is completed, the prohibited state is canceled so as to enable the charging of the battery 30.

According to the embodiment, the battery 30 and the water heater 32 corresponding to an energy storing portion are electrically connected to the sub circuit 20. The current value of the sub circuit 20 is limited by the sub breaker 22. The controller 33 controls the electric power supplied to the water heater 32 and the battery 30. When the water heater 32 and the battery 30 are simultaneously operated, the controller 33 controls the water heater 32 and the battery 30 in a manner that a current flowing through the sub breaker 22 does not exceed the allowable limit.

Specifically, the controller 33 instructs the charging of the battery 30 with a current equal to or lower than a current value calculated by subtracting the current supplied to the water heater 32 from the limit current of the sub breaker 22, using a signal of current detected by the current detector 35. Therefore, the total of the current values of the water heater 32 and the battery 30 does not exceed the allowable limit of the sub breaker 22 even if the charging of the battery 30 and the operation of the water heater 32 are simultaneously performed. Thus, it is unnecessary to increase the electric power contracted with the electric power supplier, and the water heater 32 and the battery 30 can be safely used.

In a case where the sub breaker 22 is already installed for the water heater 32 in the residence, the sub breaker 22 can be used for the charging of the battery 30 without adding an original exclusive breaker for the charging. Therefore, electric power can be safely supplied to the battery 30 with existing equipment. Thus, the electric power supply system 10 can be simplified as a whole, compared with a case where an original exclusive breaker is added only for the battery 30.

In a case where the charging of the battery 30 is prior to the heat storing operation of the water heater 32, the controller 33 prohibits the operation of the water heater 32 when the charging of the battery 30 is started. Then, when the battery 30 is charged with a predetermined electricity amount, the controller 30 cancels the prohibition of the heat storing operation of the water heater 32.

Therefore, if there is an instruction that the charging of the battery 30 is prior to the heat storing operation of the water heater 32, the operation of the water heater 32 is prohibited simultaneously when the charging of the battery 30 is started. The charging of the battery 30 has high priority and is conducted in a manner that the current does not exceed the allowable limit of the sub breaker 22 without consuming the electric power for the water heater 32.

Thereby, the battery 30 can be charged to have a predetermined state such as full-charged state in short time. Further, when the battery 30 is charged to have the predetermined state, the prohibition of the operation of the water heater 32 is canceled so as to enable to supply electricity for the water heater 32. That is, the operation of the water heater 32 is automatically started so that the convenience is increased.

In a case where the heat storing operation of the water heater 32 is prior to the charging of the battery 30, the controller 33 prohibits the charging of the battery 30 when the heat storing operation of the water heater 32 is started. Then, when the water heater 32 stores a predetermined amount of heat, the controller 30 cancels the prohibition of the charging of the battery 30.

Therefore, if there is an instruction that the heat storing operation of the water heater 32 is prior to the charging of the battery 30, the charging of the battery 30 is prohibited when the operation of the water heater 32 is started. The heat storing operation of the water heater 32 has high priority and is conducted in a manner that the current does not exceed the allowable upper limit of the sub breaker 22 without consuming the electric power for the battery 30.

Thereby, the water heater 32 can be made to have a predetermined state in short time. Further, when the storing of hot water is completed in the water heater 32, for example, the prohibition of the charging of the battery 30 is canceled so as to enable to start charging the battery 30. That is, the charging of the battery 30 is automatically started so that the convenience is increased.

The water heater 32 is a heat storing portion having the heat pump device. The consumption power of the heat pump device is easily varied in accordance with environmental condition. However, the total of the current values is restricted from exceeding the allowable upper limit of the sub breaker 22, due to the controlling performed by the controller 33, even if the consumption power of the heat pump device is varied.

Possibility that the charging of the battery 30 and the heat storing operation of the water heater 32 are simultaneously performed is increased when the cost of electric power at the midnight is set less expensive than that at the other time period due to the contract. However, the total of the current values at the midnight is restricted from exceeding the allowable limit of the sub breaker 22.

The preferred embodiment is described above. However, the present disclosure is not limited to the above embodiment.

A current detector is not limited to the current detector 35. A value of current supplied to the water heater 32 may be directly detected from the water heater 32. For example, the current detector may detect the current value by obtaining information of the current value through a signal line from the controlling portion of the water heater 32.

An energy storing portion is not limited to the water heater 32. The energy storing portion may be other member such as a battery equipped in a residence, or may be an assembly of the water heaters and batteries.

A heat storing portion is not limited to the water heater 32. The heat storing operation and the electricity storing operation are not limited to be performed in the midnight. The present disclosure may be applied to other time range other than the midnight. The midnight is not limited to pm11-am7, and the period during which the cost of electricity power is less expensive may be changed based on the contract made with the electric power utility company.

The heater of the water heater 32 is not limited to the heat pump device, and may be an electric heater, for example.

The vehicle is not limited to the PHV vehicle, may be an electric car, for example. Further, when the battery 30 is mounted to the vehicle, electricity stored in the battery 30 is not limited to be used for driving the vehicle.

The electric power supply system 10 is not limited to supply the electric power through the single parent power wiring 11 for the residence based on the single contract with the electric power utility company. Alternatively, the electric power supply system 10 may supply electric power for a factory or shop.

Such changes and modifications are to be understood as being within the scope of the present disclosure as defined by the appended claims.

What is claimed is:

1. An electric power supply system that is supplied with electric power from an electric power supplier through a power line based on an electric power supply contract comprising:
a main breaker arranged in the power line to intercept an electrical link between the electric power supplier and the power line if a first predetermined value of current flows through the power line;
a sub breaker arranged in a sub line that is electrically connected with the power line to intercept an electrical link between the main breaker and the sub line if a second predetermined value of current flows through the sub line;
an energy storing portion that stores energy by being operated with the electric power supplied from the electric power supplier, the energy storing portion being electrically connected with the sub line;
a current detector arranged in the sub line to detect a value of current supplied to the energy storing portion; and
a controller controlling an energy storing operation of the energy storing portion and controlling an electricity storing operation of a battery of a vehicle when the battery is connected to the sub line, wherein
the controller causes the battery to store electricity with an electric current equal to or lower than a current value that is calculated by subtracting the value of current detected by the current detector from the second predetermined value of current.

2. The electric power supply system according to claim 1, wherein
the controller prohibits the energy storing operation of the energy storing portion when the electricity storing operation of the battery is started in a case where the electricity storing operation of the battery is prior to the energy storing operation of the energy storing portion, and
the controller cancels the prohibition of the energy storing operation when the battery is charged with a predetermined electricity amount.

3. The electric power supply system according to claim 1, wherein
the controller prohibits the electricity storing operation of the battery when the energy storing operation of the energy storing portion is started in a case where the energy storing operation of the energy storing portion is prior to the electricity storing operation of the battery, and
the controller cancels the prohibition of the electricity storing operation of the battery when the energy storing portion stores a predetermined amount of energy.

4. The electric power supply system according to claim 1, wherein
the energy storing portion is a heat storing portion having a heat pump device, and
the heat storing portion operates the heat pump device using the electric power supplied from the electric power supplier, and stores heat as the energy.

5. The electric power supply system according to claim 1, wherein
the controller controls the electricity storing operation of the battery and the energy storing operation of the energy storing portion in a predetermined time range during which a cost of the electric power supplied from the electric power supplier is less expensive than the other time range based on the electric power supply contract.
